(19) United States
(12) Patent Application Publication
(10) Pub. No.: US 2003/0151554 A1
(43) Pub. Date: Aug. 14, 2003

(54) System, method, and product for automated workout assessment of athletic physical training

(75) Inventor: Robert J. McCarthy, Everett, MA (US)

Correspondence Address: ROBERT J. MCCARTHY, 28 HATCH ST, EVERETT, MA, 02149, US

(73) Assignee: Robert J. McCarthy, Everett, MA (US)

(21) Appl. No.: 10/249,321

(22) Filed: Apr. 1, 2003

Related U.S. Application Data
(63) Continuation-in-part of application No. 09/027,430, filed on Feb. 20, 1998, now Pat. No. 6,204,813.
(60) Provisional application No. 60/397,295, filed on Jul. 22, 2002.
(60) Provisional application No. 60/399,656, filed on Jul. 31, 2002.

(51) Int. Cl. G01S 3/02; A63B 71/00

(52) U.S. Cl. 342/450; 482/8

(57) ABSTRACT

A computer-based data processing system is described that employs at least one remote sensing device or system capable of providing time-indexed 2D or 3D spatial location, and subsequently uses the location data and other measured or derived data to automatically detect, identify, extract and characterize distinctive athletic performance features such as start and finish times of training regiments (e.g. sprints on a racetrack). Performance data is archived for historical comparison. The preferred embodiment includes visualization media, such as digitized video or icon-based graphical rendering, such that recorded performance data and derived attributes can be associated and synchronized through a common time-index reference. A specific use of this application is to automate the typical point-of-call data collection process widely used for horse racing training workouts, as well as during actual races, though the present invention also has applications that span a broad range of athletic physical training across many sports.

### CROSS REFERENCE TO RELATED APPLICATIONS

The present application is a continuation-in-part of U.S. patent application Ser. No. 09/027,430, filed Feb. 20, 1 998, now U.S. Pat. No. 6,204,813, issued Mar. 20, 2001, entitled LOCAL AREA MULTIPLE OBJECT TRACKING SYSTEM, which is commonly-owned and is incorporated herein by reference in its entirety for all purposes. The present application also claims priority to and benefit of U.S. Provisional Application Ser. No. 60/397,295, filed Jul. 22, 2002, entitled SYSTEM, METHOD, AND PRODUCT FOR AUTOMATED WORKOUT ASSESSMENT OF ATHLETIC PHYSICAL TRAINING, which is incorporated herein by reference in its entirety for all purposes. The present application is being filed concurrently with another commonly-owned co-pending application, which claims priority to U.S. Provisional Application Ser. No. 60/399,656, filed Jul. 31, 2002, entitled SYSTEM, METHOD, AND PRODUCT FOR DERIVATIVE-BASED WAGERING RACING APPLICATION, and which is also incorporated herein by reference in its entirety for all purposes.

### BACKGROUND OF INVENTION

The present invention relates generally to quantification and automated assessment of athletic physical training, particularly with respect to its utility to horse racing workouts, and more specifically to automating the chart calling performance data collection for thoroughbred, standardbred, quarter horse, trotter and harness horse training. The present invention also relates generally to other athletic and animal training, such as, but not limited to, track and field events, motorsports, water sports, multi-terrain races, Olympic contests, road races, and marathons.

Present methods of timing and scoring data collection in sports training lack many advantages available through modern technology, particularly for training activities in the horse racing industry but also more broadly in other sports as well. Athletic timing and scoring systems in general rely on manual recording and data collection techniques, and in many cases use only very basic technological assistance like binoculars, video tape recorders, and stop watches. In some cases, other technologies such as photo-eye beam or photo-finish systems may be available, but often lack the ability to distinguish ambiguities among multiple objects, or have been configured for competitive events and may not be readily adaptable to the variability of exercises typical of athletic physical training sessions.

Such systems and methods are often prone to human error and measurement processing error, and in some cases may even result in erroneous identification of the individual athlete, animal, or other object being assessed. Additionally, many present timing and scoring systems measure only discrete visible events such as start and finish times, penalties, overall score, officiating clock, etc. With modern dynamic spatial tracking technology, such as the system and methodology presented in U.S. Pat. No. 6,204,813, the additional fidelity of data collection can be employed for many novel advances in automating data processing and event feature recognition for the purpose of automated workout assessment of athletic physical training.

In thoroughbred horse racing, for example, typical morning workouts generally consist of horses, riders, and trainers working together to prepare a horse for upcoming races. During these workouts, point-of-call data is often collected by trainers, assistants, handicappers, and/or other chart callers (sometimes discreetly and without the awareness of the trainer), who either independently or together collectively determine the identity of horses based on physical characteristics, and visually detect and manually record the start and finish times and locations of individual sprints as horses travel around the racetrack.

Modern dynamic real-time object-tracking technology provides the ability to associate spatial location with unambiguous identification, measure changes in speed, detect and record start and finish times, and capture and store other relevant timing information associated with the tracked objects. The utility of such a system can be readily extended for the purposes of automating the data processing, as described by the present invention, for the benefit of all interested parties in recording and assessing athletic performance during and after workout sessions.

Prior art has been established in related areas. In particular, various methods have been presented for generating timing and scoring information related to horse racing during actual races. However, the present invention overcomes limitations in the prior art by introducing techniques to automate the quantitative assessment of training and workout sessions using attributes from spatial tracking data generated by the local area multiple object tracking system described and referenced herein, or by utilizing one or more suitable technologies with substantially similar measurement capabilities. Particular examples of related prior art for capturing timing information include: impulse radio (U.S. Pat. No. 6,504,483), event recording with a digital line camera (U.S. Pat. No. 5,657,077), cinematographic camera directed at finish line (U.S. Pat. No. 4,523,204), and a transmit/receive device using sum and difference signals to detect when an object passes the finish line (U.S. Pat. No. 4,274,076). These examples all lack specific techniques, methods, and procedures for automating the unambiguous and quantitative assessment of workouts and training sessions as described by the present invention.

Thus, the particular novelty and utility of the present invention, especially relative to and in comparison with the prior art, resides primarily in its capability to provide a systematic basis for automating the quantitative assessment of athletic physical training. Moreover, as mentioned previously, the described methods are also suitable to provide similar benefit to other athletic training and contests, such as, but not limited to, track and field events, motorsports, water sports, multi-terrain races, Olympic contests, road races, and marathons.

### SUMMARY OF INVENTION

It is therefore a principal object of this invention to provide a system and methodology for automating the quantitative assessment of training related to athletic performance, with utility to animals, human athletes, and/or other objects, based on spatial tracking data and related derived data attributes.

It is another principal object of this invention that said system and methodology comprise capability to process, store, retrieve, interface, and/or present over various media formats the spatial tracking measurement data and associated derived data attributes.

It is yet another principal object of this invention to describe the utility of said system and methodology for specific application to training of animals, and in particular, horses, wherein the assessments include selection of various parameter threshold settings to identify and determine start and end times for sprints (i.e., durations of sustained speed), speed profiles, and related timing and scoring data for athletic training assessment.

It is yet another principal object of this invention to provide the ability to present results by employing various media formats including, but not limited to, printed hardcopy, computer-generated hypertext, interactive animations, or synchronized graphic overlay with video.

It is yet another principal object of this invention to further comprise a data storage subsystem, integrated locally and/or accessible remotely over a computer network or via the Internet, so as to facilitate an ability to present comparisons of past and present performance.

It is yet another principal object of this invention to describe a method and its utility to determine the start and end time of sprints by making a computer-assisted comparison of measured speed relative to a user-selectable or computer-defined threshold for one or more athletes, animals, and/or other objects.

It is yet another principal object of this invention to facilitate the communication of, or further comprise an interface to, one or more biometric information collection devices such that the corresponding biometric data may be utilized as an input to said parameter-threshold method, or as an augmentation or index to the aforementioned spatial tracking data, as well as its further derivations or its presentation in various formats and/or various media types.

It is yet another principal object of this invention to provide the ability to generate trend analysis, using past and present performance quantification and automated assessment as recorded by said system and method, to provide simulation results for planning and optimizing athletic performance training regiments designed to achieve peak performance for a particular athletic activity (e.g., a fixed distance race) on a particular future target date (e.g., a given number of weeks from the present date).

It is yet another principal object of this invention to provide the ability to display live or queried data at a kiosk located onsite at the venue of the workout or over a remote network connection, said data presented together with visual media of the associated workout activity.

It is yet another principal object of this invention to provide the ability to set a user alert or user preference, such that the user can be paged or called back over a wireless communications device, with the live or requested data results formatted and customized for presentation over said device.

Accordingly, the present invention features a combination of data capture hardware and associated computer programs and functionality that together implement a set of executable procedures to provide automated athletic training workout assessment as described herein.

The preferred embodiment of the system of the present invention includes integration with the spread spectrum technology described in U.S. Pat. No. 6,204,813, or a technology similar in function and/or measurement capability. Based on the data available from such suitable spatial tracking capability, parameter comparison thresholds are established by a trained operator such that start and end times of sprints are automatically detected and associated by independent time index as will be further described and illustrated in the accompanying figures and details presented herein. Spatial tracking data and related derived attributes, including instantaneous speed, are recorded into a database. In real-time or post-processing, measured or estimated speed data is compared with preset thresholds to identify the start/end point coordinates, time duration, and distance traveled during a sprint.

The present invention features a particular utility of spatial tracking measurement processing and data association related to automating the collection of deterministic changes in performance based on preset thresholds or other definable criteria. Additionally, the present invention establishes the utility of unambiguous identification and time-indexing of spatial tracking data and related derivations to be integrated with various visual presentation media. Presentation media formats for end-user applications include, but are not limited to, data-integrated video graphic overlay, animation, interactive database query, static graphic, tabular, computer-generated hypertext, and printed media (e.g., racing form and program supplements for horse racing). Primary advantages of the system include accuracy of data, efficiency of operation, and remote unambiguous identification of the athletic physical training subjects.

### BRIEF DESCRIPTION OF DRAWINGS

FIG. 1 provides a block diagram overview of spatial tracking technology suitable for providing measurement data for automated workout assessment of athletic physical training.

FIG. 2 illustrates a sample system installation at a racetrack.

FIG. 3 presents a graphical depiction of the threshold-based automated detection process for identifying start and end times of sprints.

FIG. 4 presents a graphical depiction of parameterized spatial tracking data with speed profile time history and speed by segment.

FIG. 5 presents a graphical depiction of utilizing biometric data as a parameter index for automated workout assessment.

### DETAILED DESCRIPTION

In one preferred embodiment, as presented in U.S. Pat. No. 6,204,813, the present invention features a radio frequency (RF) positioning system that determines the identity and positional data such as location, velocity, and acceleration of numerous objects. The system includes a plurality of spread spectrum radio transceivers where at least one transceiver is positioned on each object. Using spread spectrum radio transceivers is advantageous because it allows unlicensed operation.

At least three spread spectrum radio transceivers transmit to and receive signals from the plurality of radio transceivers. The at least three spread spectrum radio transceivers may employ directional antennas. Also, a processor may be electrically coupled to the at least three spread spectrum radio transceivers. The processor determines the time of arrival of signals received by the spread spectrum radio transceivers.

A signal processor is coupled to the spread spectrum radio transceivers. The signal processor determines the identity and positional data of the objects. The signal processor may determine at least one of: position; time derivatives of position; orientation; and time derivatives of orientation. The signal processor may be connected to the spread spectrum radio transceivers by any network, such as an Ethernet, fiber optic or wireless network.

A memory may be used to store the identity and the positional data of the objects. A video processor may be used to display the identity and the positional data of the objects on a video display terminal. In addition, the RF positioning system may include a database engine for storing and retrieving data relating to the objects. The data may include biographical data of players in a game such as physical characteristics (height, weight, and strength and speed metrics) and previous game statistics. The video processor can display the data relating to the objects separately or together with the identity and the positional data of the objects.

The present invention also features a method of determining identity and positional data of numerous objects in a three-dimensional space. The method includes providing a plurality of spread spectrum radio transceivers where at least one transceiver is positioned on each of the numerous objects. The method also includes providing at least three spread spectrum radio transceivers. The method may include instructing the spread spectrum radio transceivers to transmit a spread spectrum signal that instructs a particular one of the plurality of spread spectrum radio transceivers to transmit a signal that can be processed to determine identity and positional data of the transceivers.

Signals are received from at least one of the spread spectrum radio transceivers with the spread spectrum radio transceivers. A signal processor is provided that is coupled to the spread spectrum radio transceivers. The signal processor de-spreads the signals to determine the identity of the objects and processes the signals to determine the positional data of the objects. The positional data may be at least one of: position; time derivatives of position; orientation; and time derivatives of orientation. The positional data of the objects may be determined from estimates of the times of arrival of the signals to each of the at least three antennas. The times of arrival may be measured relative to a synchronization clock.

The method may include storing the identity and the positional data of the objects. The method may also include displaying the identity and positional data relating to the objects on a video screen. Information specific to the objects may also be displayed on the video screen.

The present invention also features a system for monitoring the performance of sports players on a sporting field. In the present invention, said sports players may be considered human athletes, animals, or electro-mechanical devices operated by human and/or computerized control. The system includes a plurality of spread spectrum radio transceivers where at least one transceiver is positioned on each of a plurality of sports players. The plurality of spread spectrum radio transceivers may be positioned proximate the sports player's center of mass. Sensors may be positioned on the sports players and electrically coupled to the transceivers. The sensors may comprise one or more motion sensors such as impact, acceleration, or gyro sensors. The sensors may also comprise one or more non-motion sensors such as physiological sensors.

At least three spread spectrum radio transceivers are positioned proximate to the sports field. The spread spectrum radio transceivers transmit to and receive signals from the plurality of radio transceivers. A signal processor is coupled to the spread spectrum radio transceivers. The signal processor determines the identity, positional data, and related quantitative measures of performance of the sports players.

Using measurement data provided by the RF system, in particular the spatial tracking data, one skilled in the art can calculate various application-specific metrics. In addition to timing measurements, these metrics include, but are not limited to impact, total distance, directional distance, quickness, average speed, and vertical leap. The results from calculating these or other related metrics can be presented to the user in numerous ways. For example, the metrics may be presented as numerical _ID=10249321 Page 8 of 25 data, graphical data, light intensity, color, physical force or sound.

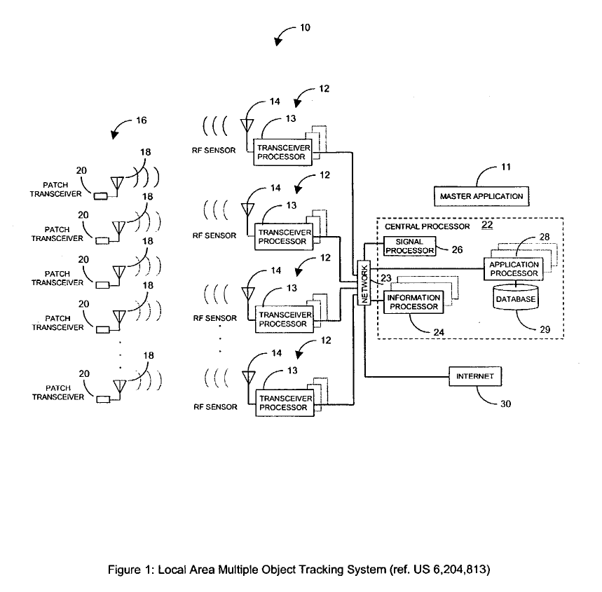

FIG. 1 provides a schematic block diagram of the local area multiple object tracking system 10 embodying the invention. The spatial tracking capability provided by the system is particularly suitable for providing measurement data for the automated workout assessment of athletic physical training as described by the present invention. The system 10 tracks the spatial locations of multiple objects simultaneously and determines location, velocity, and acceleration vectors. In one embodiment, the system 10 tracks thoroughbred horses during a race or workout.

The tracking system 10 may include a master application 11 that controls and monitors the system 10. The tracking system 10 includes at least three tower transceivers 12. Each of the tower transceivers 12 includes processors 13 and antennas 14. The tower transceivers 12 are located surrounding a local area such as a playing field or a racetrack. The tower transceivers 12 may be movable. Additional tower transceivers are used if objects become obscured as they move through the local area. Using additional tower transceivers improves accuracy and also extends battery life since lower transmitter powers can be used. In order to track objects in three dimensions, more than three tower transceivers 12 are typically used.

The antennas 14 transmit electromagnetic energy generated by the tower transceivers 12 to and receive electromagnetic energy from the objects being tracked. The antennas 14 are typically positioned around and above the local area and the objects being tracked. Such positioning is advantageous because it reduces signal interference caused by the objects being tracked. If three-dimensional positional data is required, the antennas 14 may be positioned in at least two different planes.

The antennas 14 may be directional antennas. In one embodiment, the antennas 14 may be directional with 90-degree azimuth and 90-degree to 0-degree range elevation coverage. Using directional antennas is advantageous because the directionality improves signal rejection of multi-path signals. The antennas may be mechanically or electronically rotated or steered. Additional position information or directionality can be obtained by steering the antenna's main lobe. The antennas 14 may also be mobile. The position of the antennas may be known relative to a fixed object or may be located with another system such as GPS or a laser site system.

Object patch transceivers 16 are attached to each of the objects being tracked (not shown). Antennas 18 are electrically coupled to the object patch transceivers 16 for transmitting to and receiving signals from the tower transceivers 12. The antennas 18 may be hemispherical pattern antennas that are integrated into the object patches. For example, the antennas 18 may be microstrip line patch antennas that conform to surfaces such as a player's helmet, a jockey's helmet, vest, or armband, or other athletic equipment. A processor 20 is coupled to each of the object patch transceivers 16 for processing the received signal. The object patches 16 may be remotely reconfigurable. For example, the object patch's code and code length may be remotely programmable. The object patches may also incorporate remote testing capability.

Each of the tower transceivers 12 are coupled to a central processor 22 by a network 23. The network 23 may be any high-speed communication network such as a wireless link or Ethernet. The central processor 22 includes an information processor 24, a signal processor 26, and an application processor 28. The central processor 22 may include a database engine 29 for storing and retrieving data about the objects being tracked. For example, the data may represent past movements or statistical data about the object being tracked. This data may be accessed by a video processing system and converted into graphic images or animations. The video processing system can display the data separately or together with video of the objects. The central processor 16 may employ algorithms to create animation or graphs. The data may also be made available to the Internet 30 so that it can be distributed throughout the world.

In operation, the processors 13 in the tower transceivers 12 determine the times of arrival of the signal received from the object patches 16. From the times of arrival and from knowledge of the location of the tower transceivers 12, the central processor 22 determines the location, velocity, and acceleration (LVA) of the objects. In one embodiment, the tower transceivers 12 move along with the objects being tracked. In this embodiment, the position of the tower transceivers 12 along with the times of arrival are sent to the central processor 22 to determine the LVA of the objects. The central processor 22 generates numerical and graphical representations of LVA for each of the players.

The central processor 22 may also determine various performance metrics from the positional data and from sensor data transmitted by the object patches 16. In one embodiment, accelerometer and gyro data are also transmitted by the object patches. The central processor 22 may merge the LVA data with data in a database such as a sports specific database. Certain performance metrics such as a “sprint detector” 100 may be calculated from the merged data.

Numerous techniques are used to separate the signals from each of the objects. In one embodiment, the object patches 16 are programmed with a time division multiple access (TDMA) time-slot. In other embodiments, the object patches 16 are programmed with frequency division multiple access (FDMA), code division multiple access (CDMA), or spatial diversity multiple access (SDMA). Combinations of these techniques can also be used. In one embodiment, the object patch 16 and tower transceivers 12 transmit and receive 2.4 GHz carrier signals that are binary phase shift key (BPSK) modulated with a pseudo-random noise (PRN) code.

In one embodiment, the object patches 16 transmit their code during an assigned time slot using direct sequence (DS) spread spectrum. Using spread spectrum codes is advantageous because multiple objects can use the same time slot and because it allows unlicensed operation. Frequency diversity schemes may also be used in situations where a single frequency is not reliable enough. The tower transceivers 12 are programmed with a list of object identifications and their corresponding TDMA time slots. The tower transceivers 12 listen during the appropriate time slot for each of the objects and, if an object patch signal is detected, the processor 13 determines the object's identification code and measures the signal's time-of-arrival (TOA) to the respective tower transceiver antenna 14.

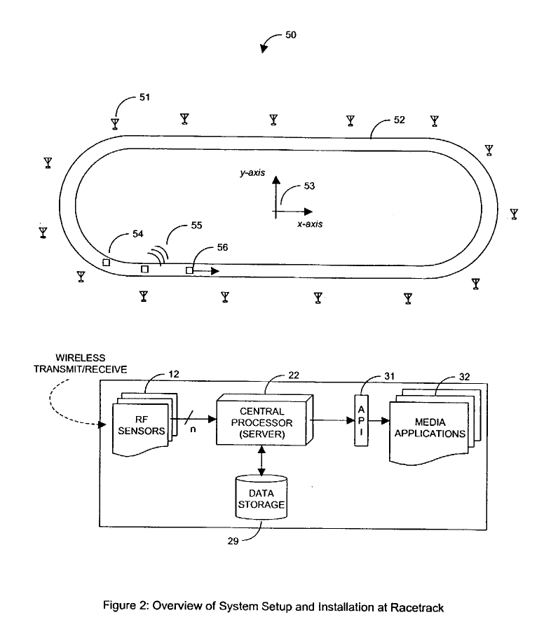

FIG. 2 illustrates a sample system installation at a racetrack, including RF sensors 12 (tower transceivers), a Central Processor (Server) 22, Application Programming Interface (API) 31, and various media applications 32. In this particular embodiment, the central processor 22 includes an information processor 24 that determines the position information from the TOA estimates provided by the tower transceivers 12. The position of the objects or players in the local area is determined from the time-difference-of-arrival (TDOA) of at least three pairs of antennas by using a transform operator that uniquely solves the set of simultaneous inequalities describing the TDOA measurements between all unique antenna pairings. These equations can be solved in closed form after linearization or by predetermined table lookup. The accuracy of the position estimates can be improved by taking multiple measurements and using least squares estimation and weighting techniques or other established optimal estimation techniques known in the art. Also, estimates of previous TDOA for each pairing may be used to improve accuracy by techniques known in the art.

An additional indicator of the object's position can be derived from the signal levels received by the tower transceivers 12. As the object patches 16 move away from the tower transceivers 12, the signal level received by the tower transceivers 12 will drop approximately proportional to the square root of distance between the tower transceivers 12 and the object patches 16. Errors in the square root dependence can be compensated for mathematically.

If the transmitted power is known or can be inferred, the signal levels received by the tower transceivers 12 are an indication of the object's position. Alternatively, if the transmitted power is not known and if the object patch antennas 18 are omni-directional, positional data can be obtained from constant delta signal level curves derived from the difference in signal levels received by all possible pairings of tower transceiver antennas 14. For directional antennas, the above techniques along with knowledge of the antenna pattern is used to determine the positional data.

The information processor 24 may also determine acceleration and rotation from sensor data. A second information processor 24″ processes the position information determined by information processor 24 into location, velocity, and acceleration (LVA) estimates for the objects. The second information processor 24″ implement various adaptive digital filters employing Kalman techniques.

The central processor 22 also includes an application processor 28 that processes the LVA estimates and presents them to the user along with data from an object database. In one embodiment, the application processor 28 is configurable in real time (on-the-fly) so that the presentation to the user of the LVA estimates and the data from an object database can be modified on demand. The application processor 28 also identifies maneuvers (i.e. specific plays in a game such as football) and object birth and death events such as a player coming onto or leaving a playing field. Maneuver identification is used to dynamically reconfigure the system and optimally assign processing resources. The central processor 22 may also include a database engine for storing and retrieving information about the objects.

From the LVA estimates, one skilled in the art can calculate various application specific metrics. These metrics include impact, total distance/gained distance, quickness, average speed around bases, and vertical leap. The results from calculating the metrics can be presented to the user in numerous ways. For example, the metrics may be presented as numerical data, graphical data, light intensity, color, physical force or sound.

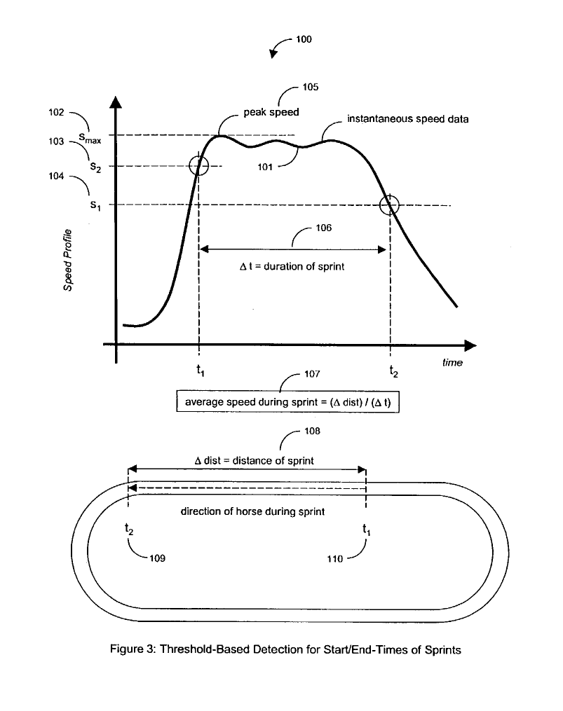

FIG. 3 presents a graphical depiction of the threshold-based detection procedure for identifying start and end times of sprints. A start-of-sprint is detected by establishing a pre-determined threshold to trigger a change of state at the time t1 110 at which the subject's (e.g., horse's or athlete's) instantaneous speed profile data 101 is determined by the computer to have exceeded (i.e., passed through) the selected speed threshold s2 103. In one embodiment, the change of state setting may be changed as a field in the respective time-stamped data record corresponding to the present measurement and to be recorded into the database. Hence, a real-time assessment can be made to identify which individuals of a group are sprinting (versus trotting for example in the horse racing and training application). Those experienced in the art will recognize this technique may be enhanced using well-known methods for data analysis and threshold detection, including for example hysteresis, dead-zone, first-order hold, buffering, and minimum time delay between states.

Similarly, an end-of-sprint indicator is detected by the time t2 109 at which the subject's (e.g., horse's or athlete's) instantaneous speed profile data 101 is determined by the computer to have passed through the selected speed threshold s1 104. The sprint is thus defined to have occurred between the start-of-sprint and end-of-sprint times with speed characteristics as described and illustrated in FIG. 3. Subsequent to the end-of-sprint detection point, the subject is determined to have returned to a lower intensity or rest state, under which conditions data may or may not be of interest and can be correspondingly stored or disregarded for the purposes of the automated training assessment.

Ultimately, a primary benefit of such artifact-based detection schemes for athletic performance training is the post-training analysis, and automated quantification and assessment thereof, and the utility of such information in the optimization of athletic performance through refinements in training techniques.

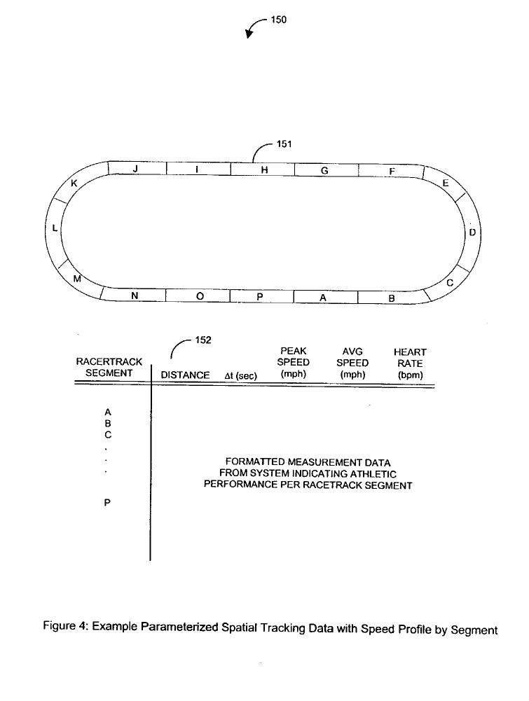

FIG. 4 presents a graphical depiction of parameterized spatial tracking data with speed profile time history and speed by segment 151. The tabulated format 152 is one possible example of the output of the system for the utility of automated physical training and workout assessment. Using the segmentation results, trainers can plan upcoming workouts with more insight into the athletic performance on a workout-to-workout basis, as well as over longer periods of time, in preparation for future races.

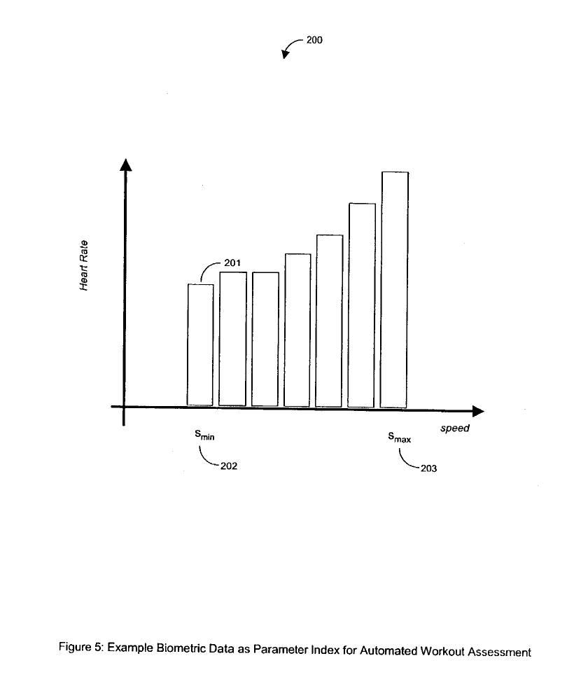

FIG. 5 presents a graphical depiction of utilizing biometric data as a parameter index for automated workout assessment 200. Biometric data such as heart rate, body temperature, etc., that can be captured and communicated wirelessly by the system can add a useful dimension to the interpretation of automated performance results. As such, one possible example includes parameterized speed versus heart rate in order to quantify and optimize training regiments for particular objectives. In this case, a speed histogram indicates that a maximum speed index is reached 203 at a multiple of the nominal heart rate typical at lower achieved speeds 202 during workouts. This information allows the trainer to design workouts with explicit consideration of cardiovascular activity levels 201.

In addition, although some aspects of the present invention were described with particular position location techniques, the invention may be practiced with other position location systems. For example, other position locating techniques such as radar, satellite imagery, astronomical observations, GPS, accelerometers, video processing, laser reflectometry, infrared imaging, sonar, directional antennas, moving antennas, and steerable antenna arrays, as well as suitable hybrids of such techniques, may be used with this invention.

Having described the preferred embodiments of the invention, it will now become apparent to one skilled in the art that other embodiments incorporating the concepts may be used and that many variations are possible which will still be within the scope and spirit of the claimed invention. Therefore, these embodiments should not be limited to disclosed embodiments but rather should be limited only by the spirit and scope of the following claims.

1. A computer-based system compatible with spatial tracking technology, such as is presented in U.S. Pat. No. 6,204,813, the integrated system comprising capability to process, store, retrieve, interface, and/or present over various media formats spatial tracking measurement data and associated derived data attributes related to athletic physical training of one or multiple subjects simultaneously for the purpose of enabling automated quantitative assessment of training sessions and athletic physical workouts.

2. The system of claim 1 with specific application to training of animals, in particular to horses, further comprising functionality wherein assessments are based on, or triggered by, selection of various parameter threshold settings to identify and determine start and end times for sprints (i.e., durations of sustained speed), profiles of speed, acceleration, or other temporal or spatial information related to athletic performance, and/or related derived timing and scoring data for athletic training assessment.

3. The system of claim 1 further comprising capability to facilitate the communication of, or provide an interface to, one or more biometric information collection devices such that the corresponding biometric data may be utilized in conjunction with other measurement data and/or derived data attributes.

4. The system of claim 1 further comprising the ability to provide various presentations of results thereof, over various media formats including, but not limited to, printed hardcopy, computer-generated hypertext, interactive animations, and/or synchronized graphic overlay with video.

5. The system of claim 1 further comprising the ability to generate trend analysis, using past and present performance quantification and automated assessment as recorded by said method and system, to provide simulation results for planning and optimizing athletic performance training regiments designed to achieve peak performance for a particular athletic activity (e.g., a fixed distance race) on a particular future target date (e.g., a given number of weeks from present date).

6. The system of claim 1 further comprising the ability to display live or queried data at a kiosk located onsite at the venue of the workout or over a remote network connection, said data presented together with visual media of the associated workout activity.

7. The system of claim 1 further comprising the ability to set a user alert or user preference, such that the user can be paged or called back over a wireless communications device, with the live or requested data results formatted and customized for presentation over said device.

8. A method for automating the assessment of athletic performance of one or multiple subjects simultaneously, said method applied during training sessions by employing spatial tracking measurements as the basis of computer-assisted analysis and presentation of said assessment results.

9. The method of claim 8 further comprising a data storage subsystem, integrated locally and/or accessible remotely over a computer network or via the Internet, so as to facilitate an ability to present comparisons of past performance.

10. The method of claim 8 further comprising the ability to determine the start and end time of sprints, i.e., durations of sustained speed, by making a computer-assisted comparison of measured speed relative to a user-selectable or computer-defined threshold for one or more objects, e.g., athletes or animals.

11. The method of claim 8 further comprising the ability to provide various presentations of results thereof, over various media formats including, but not limited to, printed hardcopy, computer-generated hypertext, interactive animations, and/or synchronized graphic overlay with video.

12. The method of claim 8 further comprising the ability to generate trend analysis, using past and present performance quantification and automated assessment as recorded by said method and system, to provide simulation results for planning and optimizing athletic performance training regiments designed to achieve peak performance for a particular athletic activity (e.g., a fixed distance race) on a particular future target date (e.g., a given number of weeks from present date).

13. The method of claim 8 further comprising the ability to display live or queried data at a kiosk located onsite at the venue of the workout or over a remote network connection, said data presented together with visual media of the associated workout activity.

14. The method of claim 8 further comprising the ability to set a user alert or user preference, such that the user can be paged or called back over a wireless communications device, with the live or requested data results formatted and customized for presentation over said device.
